(19) United States
(12) Patent Application Publication
(10) Pub. No.: US 2026/0109414 A1
(43) Pub. Date: Apr. 23, 2026

(54) VEHICLE

(71) Applicant: SUBARU CORPORATION, Tokyo (JP)

(72) Inventor: Manabu WATANABE, Tokyo (JP)

(21) Appl. No.: 19/276,210

(22) Filed: Jul. 22, 2025

(30) Foreign Application Priority Data
Sep. 26, 2024 (JP) 2024-167303

(51) Int. Cl. B62D 43/04

(52) U.S. Cl. CPC B62D 43/04

(57) ABSTRACT

A vehicle includes a suspended spare-tire attachment mechanism including an attachment linear member and first and second linear members. The attachment linear member supports a spare tire from a vehicle body when the spare tire is in an attached state in which the spare tire is attached to the vehicle. The attachment linear member breaks in case of a rear collision of the vehicle. The first and second linear members support the spare tire from the vehicle body when the attachment linear member breaks and the spare tire falls. The second linear member is disposed behind the first linear member. The first and second linear members have lengths set such that, when the attachment linear member breaks, the spare tire moves downward and forward, and the first and second linear members support the spare tire from the vehicle body while the spare tire is tilted forward and downward.

### CROSS-REFERENCE TO RELATED APPLICATIONS

The present application claims priority from Japanese Patent Application No. 2024-167303 filed on September 26, 2024, the entire contents of which are hereby incorporated by reference.

### BACKGROUND

The present technology relates to a technical field of a suspended spare-tire attachment mechanism for a vehicle.

A known suspended spare-tire attachment mechanism allows a spare tire to be attached to a vehicle body in a state such that the spare tire is suspended from the vehicle body. When the vehicle is an automobile having a rear trunk, the suspended spare-tire attachment mechanism is generally provided under the floor of the trunk.

When the suspended spare-tire attachment mechanism is provided under the rear trunk of the vehicle, there is a possibility that the spare tire will move forward and collide with another component in case of a rear collision of the vehicle. For example, when the vehicle is an engine vehicle having an engine as a drive source for wheels, a fuel tank is disposed in front of the spare-tire attachment mechanism. Therefore, the fuel tank is to be protected in case of a rear collision. When the vehicle is an electric vehicle having no engine, high-voltage components, such as a battery that serves as a power source for a motor and a drive circuit for the motor, are disposed in front of the spare-tire attachment mechanism. Therefore, these components are to be protected in case of a rear collision.

Japanese Unexamined Patent Application Publication (JP-A) No. 2018-079889 describes an example of the related art. JP-A No. 2018-079889 describes a technology for reducing the possibility of damage to a vehicle component disposed above the spare tire when a load is applied to the spare tire from the rear of the vehicle. The vehicle has a rear structure including a guide member disposed between the bottom of a vehicle body at the rear of the vehicle and the spare tire positioned below the bottom of the vehicle body and fixed to a vehicle body frame in a suspended manner by a fixing member. When a load is applied from the rear of the vehicle, the guide member comes into contact with the spare tire and moves the spare tire forward and downward.

### SUMMARY

An aspect of the disclosure provides a vehicle including a suspended spare-tire attachment mechanism including an attachment linear member, a first linear member, and a second linear member. The attachment linear member is configured to support a spare tire from a vehicle body when the spare tire is in an attached state in which the spare tire is attached to the vehicle. The attachment linear member is configured to break in case of a rear collision of the vehicle. The first linear member is configured to support the spare tire from the vehicle body when the attachment linear member breaks and the spare tire falls. The second linear member is disposed behind the first linear member and configured to support the spare tire from the vehicle body when the attachment linear member breaks and the spare tire falls. The first linear member and the second linear member have respective lengths set such that, when the attachment linear member breaks in response to the rear collision, the spare tire moves downward and forward, and the first linear member and the second linear member support the spare tire from the vehicle body while the spare tire is tilted forward and downward.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 illustrates a schematic example of the structure of a vehicle according to an embodiment;

FIG. 2 is a perspective view of a spare tire according to the embodiment;

FIG. 3 is a sectional view of the spare tire according to the embodiment;

FIG. 4 illustrates a schematic example of the structure of a spare-tire attachment mechanism according to the embodiment;

FIG. 5 is a schematic sectional view illustrating the spare-tire attachment mechanism when the spare tire has fallen vertically from an attached state;

FIG. 6 is a schematic sectional view illustrating the spare-tire attachment mechanism in case of a rear collision;

FIG. 7 illustrates a circle along which a support point of a first linear member moves and a circle along which a support point of a second linear member moves;

FIG. 8 illustrates an example of a winding mechanism for linear members included in the spare-tire attachment mechanism according to the embodiment;

FIG. 9 illustrates the relationship between a diameter of an attachment-linear-member winding portion and a diameter of a first-linear-member winding portion and a second-linear-member winding portion; and

FIG. 10 is a perspective view illustrating the spare-tire attachment mechanism with which a spare tire is attached.

### DETAILED DESCRIPTION

It is desirable to prevent a spare tire of a vehicle from colliding with a vehicle component positioned in front of the spare tire when the spare tire is attached in case of a rear collision of the vehicle.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

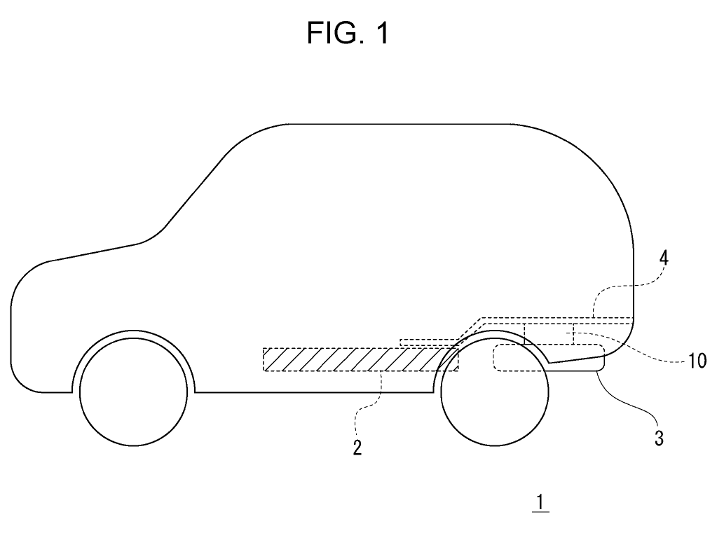

FIG. 1 illustrates a schematic example of the structure of a vehicle 1 according to the embodiment. FIG. 1 illustrates components related to the present technology among various components of the vehicle 1.

The vehicle 1 according to the embodiment is configured as an electric vehicle including a motor generator (MG) as a drive source for wheels. For example, the vehicle 1 of this example is configured as a battery electric vehicle (BEV) having no engine as a drive source for the wheels.

In this example, the vehicle 1 is assumed to have four wheels. However, the vehicle 1 according to the embodiment may be a vehicle including at least three or more wheels.

The vehicle 1, which is an electric vehicle, includes a high-voltage battery as a power supply for the MG, and the MG is provided with an inverter. During motoring of the MG, the inverter generates a driving voltage based on a voltage input from the high-voltage battery and outputs the driving voltage to the MG. During regenerative braking, the inverter charges the high-voltage battery by using the regenerative electric power generated by the MG.

The high-voltage battery has a relatively high rated output voltage, such as 200 V or 400 V.

In the drawings, a high-voltage component 2 represents high-voltage electronic components including the above-described high-voltage battery and inverter.

In this example, the high-voltage component 2 is disposed below seats of the vehicle 1, for example, below rear seats and outside a vehicle cabin.

In this example, the vehicle 1 includes a trunk behind the rear seats, and the bottom of the trunk serves as a trunk floor 4.

The vehicle 1 includes a spare-tire attachment mechanism 10 with which a spare tire 3 is attached. The spare-tire attachment mechanism 10 is configured as a suspended spare-tire attachment mechanism with which the spare tire 3 is attached to the vehicle body in a state such that the spare tire 3 is suspended from the vehicle body.

As illustrated in FIG. 1, the spare-tire attachment mechanism 10 of this example is provided below the trunk floor 4. Therefore, the spare tire 3 is attached below the trunk at the rear of the vehicle 1.

As described above, in the vehicle 1 of this example, the high-voltage component 2 is positioned below the rear seats, and the spare tire 3 is attached below the trunk with the spare-tire attachment mechanism 10. Therefore, the high-voltage component 2 is positioned in front of the spare tire 3.

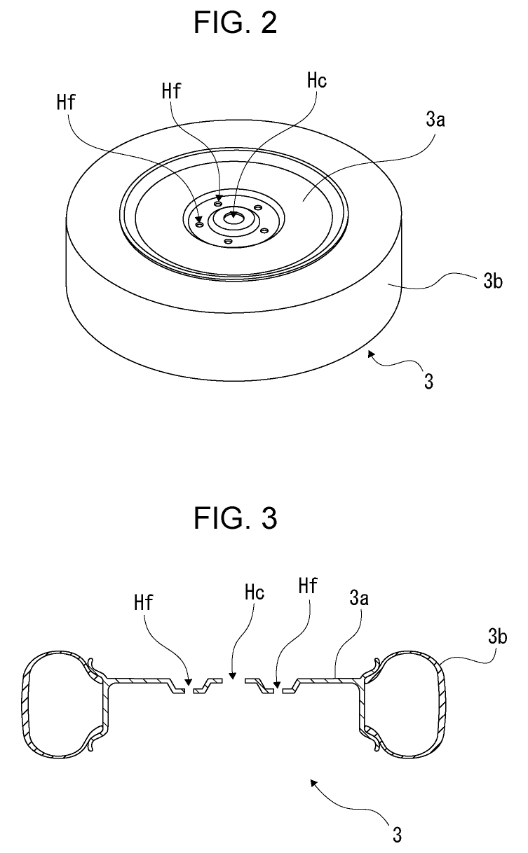

FIG. 2 is a perspective view of the spare tire 3, and FIG. 3 is a sectional view of the spare tire 3.

The spare tire 3 includes a wheel member 3a made of a metal, such as aluminum or iron, and a tire member 3b made of rubber or the like and attached to an outer periphery of the wheel member 3a.

The wheel member 3a has a center hole Hc in a central region, and wheel-fixing-member insertion holes Hf are arranged around the center hole Hc.

The wheel-fixing-member insertion holes Hf are holes through which wheel-fixing members are inserted to fix the spare tire 3 to the vehicle 1 as a traveling wheel. For example, when the traveling wheel is fixed by a nut fastening method, in other words, when hub bolts are formed on a hub of the vehicle 1, the wheel-fixing-member insertion holes Hf serve as holes through which the hub bolts are to be inserted. Alternatively, when the traveling wheel is fixed by a bolt fastening method, in other words, when the hub of the vehicle 1 has threaded holes into which wheel bolts are to be screwed, the wheel-fixing-member insertion holes serve as holes through which the wheel bolts are to be inserted.

The spare tire 3 of this example has five wheel-fixing-member insertion holes Hf. However, this is merely an example, and the number of wheel-fixing-member insertion holes Hf may be three, four, or six or more. The number and pitch of the wheel-fixing-member insertion holes Hf correspond to the number and pitch of the above-described hub bolts or threaded holes formed on the hub of the vehicle 1.

The wheel-fixing-member insertion holes Hf have the same diameter, which is smaller than a diameter of the center hole Hc.

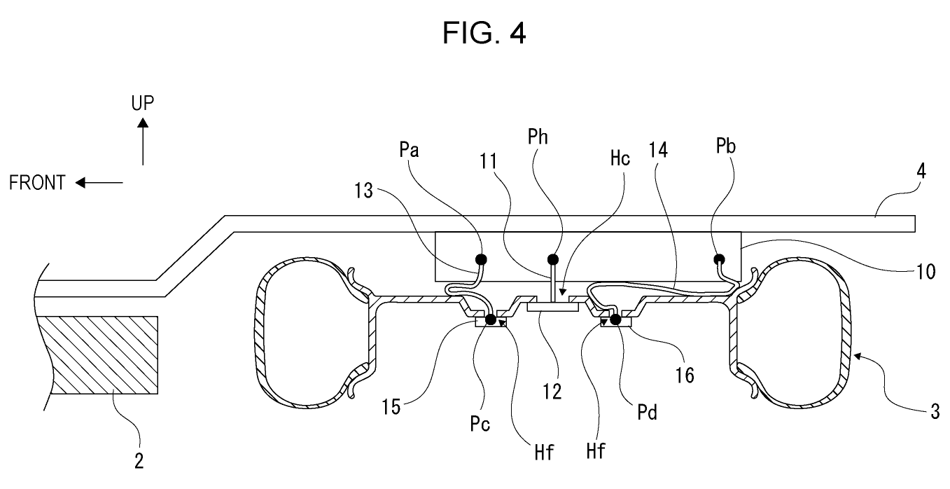

FIG. 4 illustrates a schematic example of the structure of the spare-tire attachment mechanism 10. FIG. 4 is a schematic sectional view of a region around the rear trunk of the vehicle 1. The sectional view of FIG. 4 illustrates a state in which the spare tire 3 is attached to the vehicle 1 (hereinafter referred to as an "attached state").

In the sectional views of FIGS. 4, 5, and FIG. 6, a front (forward) direction and an upward direction of the vehicle 1 are indicated by arrows.

The spare-tire attachment mechanism 10 includes an attachment linear member 11, a first drop-prevention linear member 13, and a second drop-prevention linear member 14.

In this specification, the term "linear member" means a deformable linear member, such as a cable, a rope, a chain, or a belt.

The attachment linear member 11 is a linear member configured to support the spare tire 3 from the vehicle body in the attached state, in which the spare tire 3 is attached to the vehicle 1, and break in case of a rear collision of the vehicle 1.

The attachment linear member 11 has a proximal end supported by the vehicle body and a distal end to which a support member 12 is attached. The support member 12 is, for example, a plate-shaped member made of a metal, and includes at least a portion having a length greater than the diameter of the center hole Hc in the spare tire 3 (hereinafter referred to as a "long portion").

When the spare tire 3 is in the attached state, the distal end of the attachment linear member 11 is inserted through the center hole Hc, and the long portion of the support member 12 is in contact with a periphery of the center hole Hc at both ends thereof. Thus, the attachment linear member 11 supports the spare tire 3 from the vehicle body.

A support point of the attachment linear member 11 on the vehicle body is referred to as a support point Ph.

The first drop-prevention linear member 13 supports the spare tire 3 from the vehicle body when the attachment linear member 11 breaks and the spare tire 3 falls.

The second drop-prevention linear member 14, disposed behind the first drop-prevention linear member 13, supports the spare tire 3 from the vehicle body when the attachment linear member 11 breaks and the spare tire 3 falls.

The first drop-prevention linear member 13 and the second drop-prevention linear member 14 have proximal ends supported by the vehicle body. Support points of the first drop-prevention linear member 13 and the second drop-prevention linear member 14 on the vehicle body are referred to as a support point Pa and a support point Pb, respectively, as illustrated in FIGS. 4 to 6.

The support point Pa of the first drop-prevention linear member 13 is positioned in front of the support point Ph of the attachment linear member 11, and the support point Pb of the second drop-prevention linear member 14 is positioned behind the support point Ph of the attachment linear member 11. Therefore, the second drop-prevention linear member 14 is disposed behind the first drop-prevention linear member 13.

A support member 15 is attached to a distal end of the first drop-prevention linear member 13, and a support member 16 is attached to a distal end of the second drop-prevention linear member 14.

Each of these support members 15 and 16 is, for example, a plate-shaped member made of a metal, and includes at least a portion having a length greater than the diameter of the wheel-fixing-member insertion holes Hf in the spare tire 3 (hereinafter referred to as a "long portion" similarly to the long portion of the above-described support member 12).

The first drop-prevention linear member 13 is inserted through one of the wheel-fixing-member insertion holes Hf that is positioned in a front region of the spare tire 3. When the spare tire 3 falls in response to a rear collision, the long portion of the support member 15 attached to the distal end of the first drop-prevention linear member 13 comes into contact with a periphery of the wheel-fixing-member insertion hole Hf at both ends thereof. Thus, the first drop-prevention linear member 13 supports the spare tire 3 that has fallen from the vehicle body.

The second drop-prevention linear member 14 is inserted through one of the wheel-fixing-member insertion holes Hf that is positioned in a rear region of the spare tire 3. When the spare tire 3 falls in response to a rear collision, the long portion of the support member 16 attached to the distal end of the second drop-prevention linear member 14 comes into contact with a periphery of the wheel-fixing-member insertion hole Hf at both ends thereof. Thus, the second drop-prevention linear member 14 supports the spare tire 3 that has fallen from the vehicle body.

Since the first drop-prevention linear member 13 and the second drop-prevention linear member 14 support the spare tire 3 that has fallen from the vehicle body, the spare tire 3 is prevented from being dropped from the vehicle body.

In this example, when the spare tire 3 is in the attached state, the long portions of the support members 15 and 16 are attached to the peripheries of the corresponding wheel-fixing-member insertion holes Hf so that the support members 15 and 16 do not fall due to their own weights. For example, the support members 15 and 16 of this example include magnets, and are attached to the wheel member 3a made of iron by magnetic attraction. The method for attaching the support members 15 and 16 to the wheel member 3a is not limited to the method using magnets, and other methods, such as a method using touch fasteners, may be used.

When the first drop-prevention linear member 13 and the second drop-prevention linear member 14 support the spare tire 3 that has fallen in response to a rear collision from the vehicle body, support points of the first drop-prevention linear member 13 and the second drop-prevention linear member 14 on the spare tire 3 are referred to as a support point Pc and a support point Pd, respectively, as illustrated in FIGS. 4 to 6.

In the spare-tire attachment mechanism 10 according to the present embodiment, the lengths of the first drop-prevention linear member 13 and the second drop-prevention linear member 14 are set as described below. That is, the lengths of the first drop-prevention linear member 13 and the second drop-prevention linear member 14 are set such that, when the attachment linear member 11 breaks in response to a rear collision, the spare tire 3 moves downward and forward, and the first drop-prevention linear member 13 and the second drop-prevention linear member 14 support the spare tire 3 from the vehicle body while the spare tire 3 is tilted forward and downward.

In this example, the length of the second drop-prevention linear member 14 from the support point Pb to the support point Pd is greater than the length of the first drop-prevention linear member 13 from the support point Pa to the support point Pc. In other words, when the first drop-prevention linear member 13 and the second drop-prevention linear member 14 support the spare tire 3 from the vehicle body, the length of the second drop-prevention linear member 14 from the support point on the vehicle body to the support point on the spare tire 3 is greater than the length of the first drop-prevention linear member 13 from the support point on the vehicle body to the support point on the spare tire 3.

Since the spare tire 3 falls when the attachment linear member 11 breaks in response to a rear collision as described above, the lengths of the first drop-prevention linear member 13 and the second drop-prevention linear member 14 are greater than the length of the attachment linear member 11 when the spare tire 3 is in the attached state. Therefore, when the spare tire 3 is in the attached state, the first drop-prevention linear member 13 and the second drop-prevention linear member 14 are slack, as illustrated in FIG. 4.

The method for attaching the spare tire 3 in this example will be described below.

Due to the above-described settings of the lengths and arrangement of the first drop-prevention linear member 13 and the second drop-prevention linear member 14, when the attachment linear member 11 breaks in response to a rear collision and when the first drop-prevention linear member 13 and the second drop-prevention linear member 14 support the spare tire 3 from the vehicle body, the spare tire 3 is tilted forward and downward based on the principles described below.

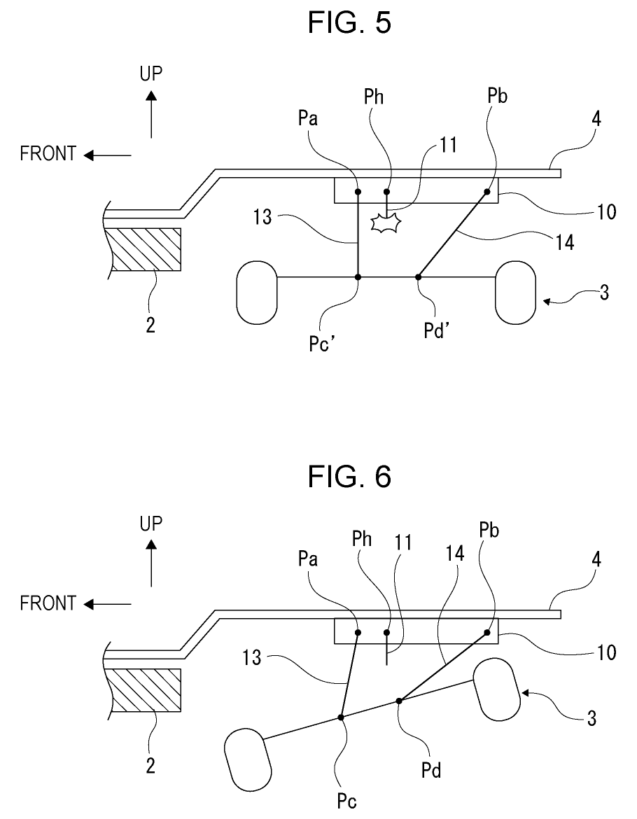

FIG. 5 is a schematic sectional view illustrating the spare-tire attachment mechanism 10 when the spare tire 3 has fallen vertically from the attached state. FIG. 6 is a schematic sectional view of the spare-tire attachment mechanism 10 when the spare tire 3 has moved downward and forward in response to a rear collision and when the first drop-prevention linear member 13 and the second drop-prevention linear member 14 support the spare tire 3 from the vehicle body.

Referring to FIG. 5, support points at which the first drop-prevention linear member 13 and the second drop-prevention linear member 14 support the spare tire 3 that has fallen vertically are referred to as support points Pc' and Pd'. The lengths of the first drop-prevention linear member 13 and the second drop-prevention linear member 14 are set so that a line segment Pc'-Pd' connecting the support point Pc' and the support point Pd' is horizontal.

In case of a rear collision, the spare tire 3 experiences an acceleration in a rear-to-front direction of the vehicle 1, and also experiences a gravitational acceleration when the attachment linear member 11 breaks. In other words, the spare tire 3 experiences forward and downward accelerations.

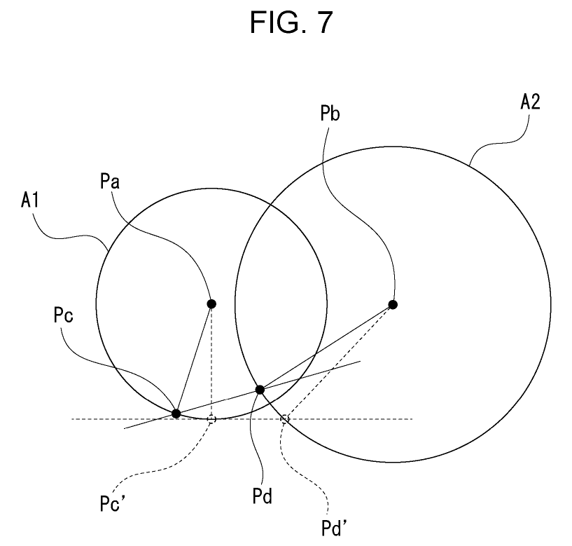

Assume that the lengths and arrangement of the first drop-prevention linear member 13 and the second drop-prevention linear member 14 are set as described above. When the spare tire 3 suspended from the vehicle body by the first drop-prevention linear member 13 and the second drop-prevention linear member 14 is moved in the front-rear direction, as illustrated in FIG. 7, the support point Pc of the first drop-prevention linear member 13 moves along a circle A1 centered on the support point Pa and having a radius equal to the length from the support point Pa to the support point Pc. The support point Pd of the second drop-prevention linear member 14 moves along a circle A2 centered on the support point Pb and having a radius equal to the length from the support point Pb to the support point Pd. The circle A2 is greater than the circle A1 in diameter.

The state of a rear collision illustrated in FIG. 6 may be regarded as a state in which a forward acceleration is additionally applied in a vertical falling state illustrated in FIG. 5. Therefore, as is clear from FIG. 7, in case of a rear collision illustrated in FIG. 6, the support points Pc and Pd move forward from the support points Pc' and Pd', respectively. At this time, due to the difference in diameter between the circles A1 and A2, the support point Pc is positioned below the support point Pd. In other words, in case of a rear collision, the spare tire 3 is tilted forward and downward as illustrated in FIG. 6.

As described above, according to the spare-tire attachment mechanism 10 of the embodiment, when the attachment linear member 11 breaks in response to a rear collision, the spare tire 3 moves downward and forward, and the first drop-prevention linear member 13 and the second drop-prevention linear member 14 support the spare tire 3 from the vehicle body while the spare tire 3 is tilted forward and downward.

Thus, in case of a rear collision of the vehicle 1, the spare tire 3 can be prevented from colliding with the high-voltage component 2.

In the above-described example, the lengths of the first drop-prevention linear member 13 and the second drop-prevention linear member 14 are set so that the line segment Pc'-Pd' is horizontal. However, this condition is not necessary to cause the spare tire 3 to be tilted forward and downward when the first drop-prevention linear member 13 and the second drop-prevention linear member 14 support the spare tire 3 from the vehicle body in response to a rear collision. When the first drop-prevention linear member 13 and the second drop-prevention linear member 14 support the spare tire 3 from the vehicle body in response to a rear collision, the spare tire 3 can be tilted forward and downward as long as the length of the second drop-prevention linear member 14 from the support point Pb to the support point Pd is greater than the length of the first drop-prevention linear member 13 from the support point Pa to the support point Pc while the first drop-prevention linear member 13 and the second drop-prevention linear member 14 support the spare tire 3 from the vehicle body.

In the above-described example, the first drop-prevention linear member 13 and the second drop-prevention linear member 14 are slack when the spare tire 3 is in the attached state. In this case, when the spare tire 3 is in the attached state, the first drop-prevention linear member 13 and the second drop-prevention linear member 14 may partially hang below a disc surface of the wheel member 3a at the distal ends thereof.

To prevent the linear members from partially hanging as described above, the support members 15 and 16 may, for example, be fixed to the wheel member 3a (for example, to the peripheries of the wheel-fixing-member insertion holes Hf through which the linear members are inserted) by using magnets, touch fasteners, or the like.

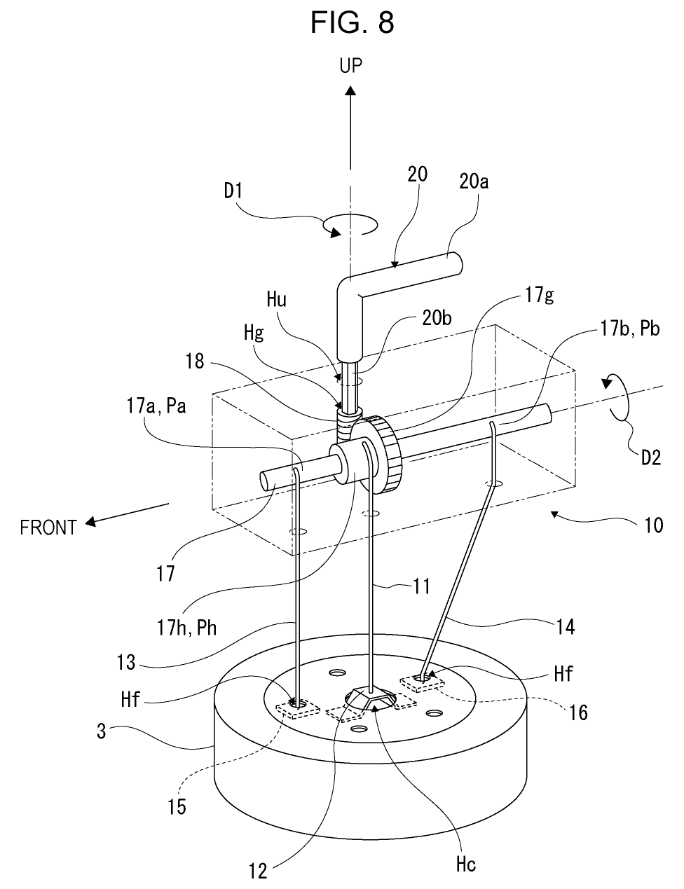

An example of a winding mechanism for winding the linear members included in the spare-tire attachment mechanism 10 will be described with reference to the perspective view of FIG. 8.

As illustrated in FIG. 8, the spare-tire attachment mechanism 10 includes a winding shaft 17 around which the attachment linear member 11, the first drop-prevention linear member 13, and the second drop-prevention linear member 14 are all wound.

Although not illustrated in detail, the winding shaft 17 is rotatably supported by the vehicle body. An axial direction of the winding shaft 17 is parallel to the front-rear direction of the vehicle 1. The winding shaft 17 includes a gear unit 17g, and the entire body of the winding shaft 17 rotates when the gear unit 17g is driven.

The spare-tire attachment mechanism 10 of this example includes a drive gear 18 that drives the gear unit 17g, and has an access hole Hu that enables access to the drive gear 18. The access hole Hu is a hole that extends through the trunk floor 4 in the up-down direction.

In this example, a worm gear is used as the drive gear 18. An axial direction of the drive gear 18 is parallel to the up-down direction. The drive gear 18 has a tool attachment hole Hg that opens in an upper surface of the drive gear 18 and extends in the up-down direction.

As illustrated in FIG. 8, in this example, a driving tool 20 used to drive the drive gear 18 is a tool including an L-shaped handle 20a and a shaft 20b that projects from the handle 20a. The tool attachment hole Hg in the drive gear 18 serves as a hole to which the distal end of the shaft 20b is fitted.

The winding shaft 17 includes an attachment-linear-member winding portion 17h around which the attachment linear member 11 is wound, a first-linear-member winding portion 17a around which the first drop-prevention linear member 13 is wound, and a second-linear-member winding portion 17b around which the second drop-prevention linear member 14 is wound.

The attachment-linear-member winding portion 17h is a portion of the winding shaft 17 to which the proximal end of the attachment linear member 11 is fixed. In other words, the attachment-linear-member winding portion 17h serves as the support point of the attachment linear member 11 on the vehicle body, and corresponds to the above-described support point Ph.

The first-linear-member winding portion 17a is a portion of the winding shaft 17 to which the proximal end of the first drop-prevention linear member 13 is fixed. The second-linear-member winding portion 17b is a portion of the winding shaft 17 to which the proximal end of the second drop-prevention linear member 14 is fixed. In other words, the first-linear-member winding portion 17a serves as the support point of the first drop-prevention linear member 13 on the vehicle body, and corresponds to the above-described support point Pa. The second-linear-member winding portion 17b serves as the support point of the second drop-prevention linear member 14 on the vehicle body, and corresponds to the above-described support point Pb.

In the spare-tire attachment mechanism 10 of the present embodiment, the attachment-linear-member winding portion 17h has a diameter greater than those of the first-linear-member winding portion 17a and the second-linear-member winding portion 17b.

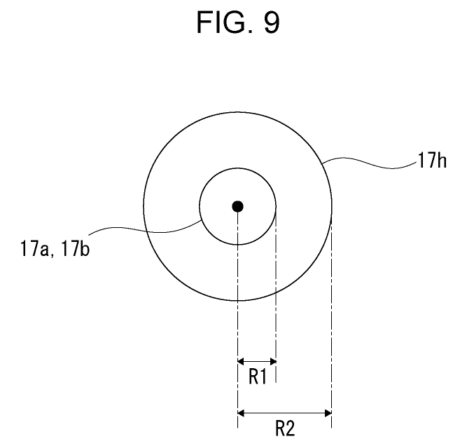

In this example, as illustrated in FIG. 9, the diameter of the first-linear-member winding portion 17a and the diameter of the second-linear-member winding portion 17b are both R1, and the attachment-linear-member winding portion 17h has a diameter R2 greater than R1.

When the spare tire 3 is not yet attached, as illustrated in FIG. 8, the spare tire 3 is placed on the ground at a position below the spare-tire attachment mechanism 10. In this state, as illustrated in FIG. 8, the distal end of the attachment linear member 11 is inserted through the center hole Hc in the spare tire 3 so that the above-described long portions of the support member 12 are capable of coming into contact with the periphery of the center hole Hc and that the attachment linear member 11 is capable of supporting the spare tire 3 from the vehicle body.

In addition, the distal end of the first drop-prevention linear member 13 and the distal end of the second drop-prevention linear member 14 are inserted through the corresponding wheel-fixing-member insertion holes Hf so that the long portions of the support members 15 and 16 are attached to the peripheries of the corresponding wheel-fixing-member insertion holes Hf by the effect of the magnets as described above.

To attach the spare tire 3, a worker, such as a driver, performs an operation of rotating the handle 20a in a direction D1 illustrated in FIG. 8 while the shaft 20b of the driving tool 20 is inserted through the access hole Hu and the distal end of shaft 20b is fitted to the tool attachment hole Hg in the drive gear 18.

As a result of this operation, the drive gear 18 is rotated and the rotating power of the drive gear 18 is transmitted to the gear unit 17g, so that the winding shaft 17 is rotated in a direction D2 illustrated in FIG. 8. Thus, the attachment linear member 11, the first drop-prevention linear member 13, and the second drop-prevention linear member 14 are wound around the winding shaft 17. When the attachment linear member 11 is wound, the spare tire 3 is lifted upward from the ground. For example, the spare tire 3 is lifted upward to a predetermined height position, such as a position at which the spare tire 3 comes into contact with a lower surface of the spare-tire attachment mechanism 10, so that the spare tire 3 is set to the attached state.

Since the worm gear is used as the drive gear 18, the worm gear provides a self-locking function that prevents the spare tire 3 from falling due to its own weight.

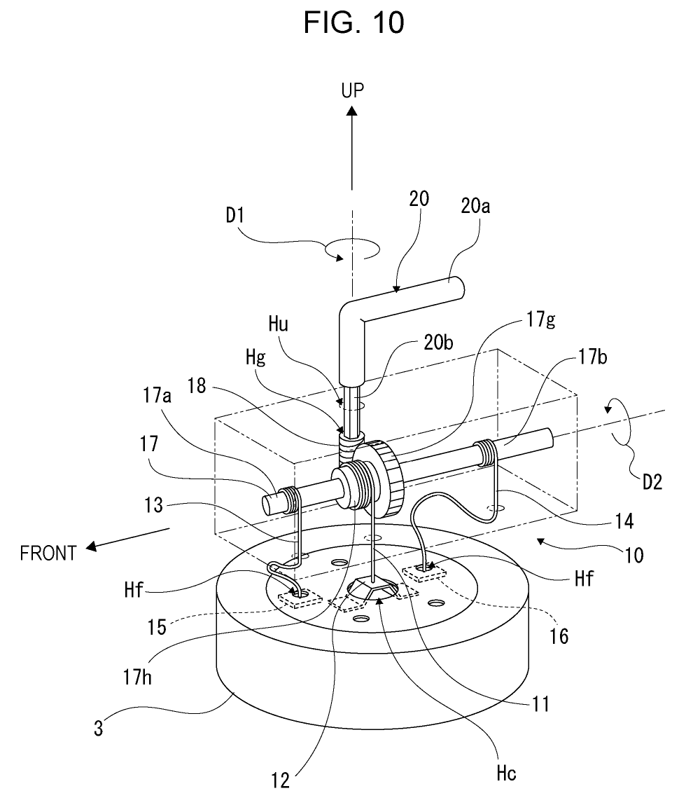

As described above, the attachment-linear-member winding portion 17h has a diameter greater than those of the first-linear-member winding portion 17a and the second-linear-member winding portion 17b. Therefore, as illustrated in FIG. 10, the first drop-prevention linear member 13 and the second drop-prevention linear member 14 can be made slack when the spare tire 3 is raised to an attachment position by rotating the winding shaft 17.

Since the first drop-prevention linear member 13 and the second drop-prevention linear member 14 are slack as described above after the spare tire 3 is raised to the attachment position, the spare tire 3 is capable of falling in case of a rear collision, so that the spare tire 3 is capable of moving downward and forward. Therefore, by performing a single operation of rotating the winding shaft 17, the spare tire 3 can be prevented from colliding with the high-voltage component 2 in case of a rear collision.

The present embodiment is not limited to the above-described examples, and various modifications are possible.

For example, although the vehicle to which the present technology is applied is a BEV in the above-described example, the present technology can also be suitably applied to an engine vehicle in which an engine serves as a drive source for the wheels. In an engine vehicle, a fuel tank is disposed in front of the spare tire 3 in the attached state. Therefore, the fuel tank can be protected.

In addition, in the above-described example, the first drop-prevention linear member 13 and the second drop-prevention linear member 14 are slack when the spare tire 3 is in the attached state. However, it is not necessary that the first drop-prevention linear member 13 and the second drop-prevention linear member 14 be slack.

For example, a structure for urging the proximal ends of the first drop-prevention linear member 13 and the second drop-prevention linear member 14 in a winding direction may be used so that the first drop-prevention linear member 13 and the second drop-prevention linear member 14 are not slack when the spare tire 3 is in the attached state. It goes without saying that, in this case, the urging force is set so that the first drop-prevention linear member 13 and the second drop-prevention linear member 14 are extracted in a direction opposite to the winding direction when the spare tire 3 falls in case of a rear collision.

When the first drop-prevention linear member 13 and the second drop-prevention linear member 14 are not slack when the spare tire 3 is in the attached state, the linear members can be prevented from generating abnormal sound or being damaged due to interference with other components during vibrations generated while the vehicle 1 is moving.

In addition, in the above-described example, the linear members are inserted through the holes formed in the wheel member 3a, and the spare tire 3 is supported by the peripheries of the holes and the support members provided at the distal ends of the linear members. When the spare tire 3 is supported by using the peripheries of the holes in the wheel member 3a as described above, it is not necessary that the support members be members formed separately from the linear members. The support members may be portions of the linear members, for example, knots of the linear members.

The method of supporting the spare tire 3 by using the peripheries of the holes formed in the wheel member 3a is merely an example, and other support methods may be used. For example, the distal ends of the linear members may be provided with clips that are engaged with projections provided on the wheel member 3a, or be fixed to the projections with bolts.

In addition, although one first drop-prevention linear member 13 and one second drop-prevention linear member 14 are provided in the above-described example, the first drop-prevention linear member 13 and/or the second drop-prevention linear member 14 may be provided in a plurality.

For example, one first drop-prevention linear member 13 and two (left and right) second drop-prevention linear members 14 may be provided to constitute a three-point support. Alternatively, for example, two (left and right) first drop-prevention linear members 13 and two (left and right) second drop-prevention linear members 14 may be provided to constitute a four-point support.

As described above, a vehicle (vehicle 1) according to the embodiment includes a suspended spare-tire attachment mechanism (spare-tire attachment mechanism 10) including an attachment linear member (attachment linear member 11), a first linear member (first drop-prevention linear member 13), and a second linear member (second drop-prevention linear member 14). The attachment linear member is configured to support a spare tire from a vehicle body when the spare tire is in an attached state in which the spare tire is attached to the vehicle. The attachment linear member is configured to break in case of a rear collision of the vehicle. The first linear member is configured to support the spare tire from the vehicle body when the attachment linear member breaks and the spare tire falls. The second linear member is disposed behind the first linear member and configured to support the spare tire from the vehicle body when the attachment linear member breaks and the spare tire falls. The first linear member and the second linear member have lengths set such that, when the attachment linear member breaks in response to a rear collision, the spare tire moves downward and forward, and the first linear member and the second linear member support the spare tire from the vehicle body while the spare tire is tilted forward and downward.

According to the above-described spare-tire attachment mechanism of the embodiment, when the attachment linear member breaks in response to a rear collision, the spare tire moves downward and forward, and the first and second linear members support the spare tire from the vehicle body while the spare tire is tilted forward and downward.

Accordingly, in case of a rear collision of the vehicle, the spare tire can be prevented from colliding with a vehicle component that is positioned in front of the spare tire when the spare tire is in the attached state.

In particular, when the vehicle component is a high-voltage component or a fuel tank, the safety of the vehicle can be improved by preventing the spare tire from colliding with these components.

In addition, in the vehicle of the embodiment, when the first linear member and the second linear member support the spare tire from the vehicle body, a length of the second linear member from a support point (support point Pb) on the vehicle body to a support point (support point Pd) on the spare tire is greater than a length of the first linear member from a support point (support point Pa) on the vehicle body to a support point (support point Pc) on the spare tire.

In this case, the spare tire that has fallen in response to a rear collision can be tilted forward and downward.

Therefore, in case of a rear collision of the vehicle, the spare tire can be prevented from colliding with a vehicle component that is positioned in front of the spare tire when the spare tire is in the attached state.

In the vehicle according to the embodiment, when the spare tire is in the attached state, the first linear member and the second linear member are inserted through wheel-fixing-member insertion holes (wheel-fixing-member insertion holes Hf) in a wheel member of the spare tire.

Accordingly, holes formed in the wheel member in advance to receive wheel-fixing members for fixing the spare tire as a traveling wheel may be used as linear-member insertion holes that enable the first and second linear members to support the spare tire that falls.

Therefore, it is not necessary to prepare a dedicated spare tire having holes for inserting the first and second linear members in addition to the wheel-fixing-member insertion holes, and the costs can be reduced.

In addition, in the vehicle according to the embodiment, the spare-tire attachment mechanism includes a winding shaft (winding shaft 17) around which the attachment linear member, the first linear member, and the second linear member are all wound.

Accordingly, in the process of attaching the spare tire, the attachment linear member, the first linear member, and the second linear member can all be wound by rotating the winding shaft.

Therefore, the work load of winding the attachment linear member, the first linear member, and the second linear member in the process of attaching the spare tire can be reduced.

In addition, in the vehicle according to the embodiment, a portion of the winding shaft around which the attachment linear member is wound has a diameter (R2) greater than diameters (R1) of portions of the winding shaft around which the first linear member and the second linear member are wound.

Accordingly, the first and second linear members can be made slack when the spare tire is raised to the attachment position by rotating the winding shaft.

When the first and second linear members are slack after the spare tire is raised to the attachment position, the spare tire is capable of falling in case of a rear collision, so that the spare tire is capable of moving downward and forward. Therefore, according to the above-described structure, by performing a single operation of rotating the winding shaft, the spare tire can be prevented from colliding with the vehicle component in front of the spare tire in case of a rear collision. In other words, the process of attaching the spare tire such that the spare tire is prevented from colliding with the vehicle component in front of the spare tire in case of a rear collision can be simplified.

According to this technology, in case of a rear collision of a vehicle, a spare tire of the vehicle can be prevented from colliding with a vehicle component positioned in front of the spare tire when the spare tire is attached.

1. A vehicle comprising:
a suspended spare-tire attachment mechanism comprising:
an attachment linear member configured to support a spare tire from a vehicle body when the spare tire is in an attached state in which the spare tire is attached to the vehicle, the attachment linear member being configured to break in case of a rear collision of the vehicle;
a first linear member configured to support the spare tire from the vehicle body when the attachment linear member breaks and the spare tire falls; and
a second linear member disposed behind the first linear member and configured to support the spare tire from the vehicle body when the attachment linear member breaks and the spare tire falls,
wherein the first linear member and the second linear member have respective lengths set such that, when the attachment linear member breaks in response to the rear collision, the spare tire moves downward and forward, and the first linear member and the second linear member support the spare tire from the vehicle body while the spare tire is tilted forward and downward.

2. The vehicle according to claim 1, wherein, when the first linear member and the second linear member support the spare tire from the vehicle body, a length of the second linear member from a support point on the vehicle body to a support point on the spare tire is greater than a length of the first linear member from a support point on the vehicle body to a support point on the spare tire.

3. The vehicle according to claim 1, wherein, when the spare tire is in the attached state, the first linear member and the second linear member are inserted respectively through wheel-fixing-member insertion holes in a wheel member of the spare tire.

4. The vehicle according to claim 1, wherein the suspended spare-tire attachment mechanism further comprises a winding shaft around which the attachment linear member, the first linear member, and the second linear member are all wound.

5. The vehicle according to claim 4, wherein a portion of the winding shaft around which the attachment linear member is wound has a diameter greater than a diameter of a portion of the winding shaft around which the first linear member is wound and a diameter of a portion of the winding shaft around which the second linear member is wound.
